(19) United States
(12) Patent Application Publication
(10) Pub. No.: US 2004/0205451 A1
(43) Pub. Date: Oct. 14, 2004

(54) Method and system for identifying and distinguishing words contained within an electronic message in order to convey significance

(75) Inventor: Lee Anne Kowalski, Cupertino, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: INTERNATIONAL BUSINESS MACHINES CORPORATION, Armonk, NY

(21) Appl. No.: 09/928,599

(22) Filed: Aug. 13, 2001

(51) Int. Cl. G06F 15/00

(52) U.S. Cl. 715/500; 715/530

(57) ABSTRACT

The invention discloses an method, apparatus and article of manufacture for identifying and distinguishing words contained within an electronic message, including the steps of scanning and comparing message terms in an electronic message to significant terms from an online registry to identify any matched significant message terms and making distinct the matched significant message term to indicate significance to a reader.

### BACKGROUND OF THE INVENTION

1. Field of the Invention

The present invention generally relates to electronic message management and processing, and particularly to methods and systems for creating and reading electronic messages.

2. Description of Related Art

Currently, e-mail users may receive large numbers of e-mail messages each day. Those using e-mail in the workplace and those e-mail users considered critical to a project or team are particularly inundated with e-mail. In addition, many of the received messages may be addressed to more than one individual, wherein the author sends the exact same message to more than one recipient at the same time. In many situations, the author may intend that certain parts of the message body are more significant or important to some of the recipients than they are to the others. For example, an author may send a message to ten people (ten people on the “To:” line of the message) to notify them all of the existence of a particular issue and in the same message the author may ask specific questions of two of them and assign actions (i.e. “to dos”) to two others. The problem is that all ten of the recipients must take the time to read the entire message to see which areas are important to them, even if only a small section is applicable to them. Without reading the entire message, each recipient cannot easily determine which portions they need to pay attention to and which portions are unimportant to them. In their haste to catch up on reading many e-mail messages each day, they can easily overlook a question or action that the sender of the message wrote in the message specifically for them and thereby cause delays in progress of the situation.

A simple solution to this problem may be obtained by manually flagging or making distinct names and terms within messages using fonts and color. However, this would require significantly more time on the part of the e-mail author. In addition, this would not help the e-mail reader who receives a message that has not been generated by an author to include these markings.

Other e-mail processing approaches may sort e-mail automatically to help alleviate the global problem of people trying to efficiently process all of the e-mail that they receive. For example, the recipient users may register a set of words that they want to be used in the lookup. Then, when e-mail messages are received in their in-box, they are scanned for occurrences of those words. Based on the frequency that those words occur in the messages, the messages are sorted into different categories for the recipient. However, this approach does not afford the user (author or recipient) the ability to customize the appearance and emphasis given particular words when e-mail is created as well as when it is read by a recipient.

Although the problems described above are most commonly found in the use of e-mail as it is the most ubiquitous form of electronic messaging, these problems are not exclusive to e-mail. They are equally applicable to any other form of electronic messaging. Some examples include various forms of online instant messaging (e.g. Lotus Sametime™, AOL Instant Messenger™, etc.) as well as messaging services for handheld devices (e.g. short messaging system (SMS) for cellular phones and pagers and others).

Accordingly, there is a need for a system and method within electronic messaging systems and programs that will minimize the time required to read electronic messages by allowing certain words that are contained within the electronic message to be quickly and easily identified and distinguished within the electronic message from the rest of the words in the message. There is also a need for such systems and methods to be conveniently employed when the electronic message is created as well as when it is read. The present invention meets all these needs and is generally applicable to all forms of electronic messaging as described above.

### SUMMARY OF THE INVENTION

To overcome the limitations in the prior art described above, and to overcome other limitations that will become apparent upon reading and understanding the present specification, the present invention discloses a method, apparatus and article of manufacture for identifying and distinguishing words contained within an electronic message in order to convey significance.

The invention discloses an method, apparatus and article of manufacture for identifying and distinguishing words contained within an electronic message, including the steps of scanning and comparing message terms in an electronic message to significant terms from an online registry to identify any matched significant message terms and making distinct the matched significant message term to indicate significance to a reader.

A typical method of the present invention comprises the steps of collecting significant terms, locating those terms inside an electronic message, and, within the message itself, distinguishing the significant terms from the other “non-significant” terms so that they can be quickly and easily identified by the reader.

The system and method can be available at the time the message is created by the author and/or at the time the message is read by the recipient, and the words are ones that either the author or recipient can determine should convey significance.

The present invention is different from the previously described sorting approach in a number of ways. First, the present invention can be used both at the source by the electronic message author and by the recipient. The author can choose words to make significant and they will get the attention of the recipient in the way that the author specifies. With the other sorting approach, the recipient chooses and registers the words that they think are important to find automatically. The terms registered by the recipient might not be the same as the terms that the author would consider important. Therefore, the present invention is more flexible than the other technology because it can be used both at the creation of the electronic message and at its reception. In addition, the other technology merely sorts the electronic message into categories (e.g., in a folder). It does not alter the electronic message appearance to make it easier to read. The recipient must still open each message and read it through to find the areas that contain the words that the user registered as significant. In the present invention, those words have an indication (for example, bold font) within the message itself so that the recipient can easily spot them as they scan the text.

### BRIEF DESCRIPTION OF THE DRAWINGS

Referring now to the drawings in which like reference numbers represent corresponding parts throughout:

FIG. 1 schematically illustrates the environment of a typical embodiment of the present invention;

FIG. 2 is a flowchart that illustrates the logic performed by the invention for an electronic message author;

FIG. 3 is a flowchart that illustrates the logic performed by the invention for an electronic message recipient; and

FIG. 4 illustrates a typical apparatus of the invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

Authors of electronic messages can easily find terms in their messages which they want to call to the attention of particular electronic message recipients and distinguish those terms so that they are readily visible to those particular recipients. This reduces the likelihood of a recipient overlooking something in the message that the author wants them to read. Individual recipients of the electronic messages can easily find those terms in the message that are important to each of them. This reduces the time each person spends reading their electronic message, as they can scan each message and easily find the portions that are important to them.

Throughout the following detailed description the following terms shall be used, defined as follows.

“Significant” is defined as those words (which includes proper names, or words invented by the user of the invention) which the user considers would be important to read if they are contained in that user's electronic messages. For example, a manager would consider the names of his employees to be significant for electronic messages that he sends or receives.

“Distinct” and “distinguished” are also significant terms. A term contained in an electronic message is “distinct” if it has a quality that makes it stand out from the other terms in the electronic message, and it is said be “distinguished” from the rest of the text. For example, if most of the text in an electronic message is in normal font and some terms are in bold font, those terms that are in bold font are “distinct” or “distinguished” from the rest of the text. Ways in which terms can be made distinct include but are not limited to using different fonts, using different colors, and having an image displayed next to them.

With the present invention, electronic message authors may define a set of terms (which may be words, proper names, invented words, etc.) that they want to be registered as significant terms. When finished composing an electronic message, the authors invoke a process which scans the electronic message and locates the registered terms in the body of the message. For each occurrence of a registered term, the process asks the author whether it should make that occurrence to appear distinct within the message.

In addition, electronic message recipients may also define a set of terms (which may also be words, proper names, invented words, etc.) that they want to be registered as significant terms. When they open an electronic message to be read, the recipients invoke a process which scans the electronic message, locates the registered terms in the body of the message, and makes the occurrences appear distinct within the message.

The set of terms used may be the same or different for a given user when the user is a recipient or an author of electronic message.

### Hardware Environment

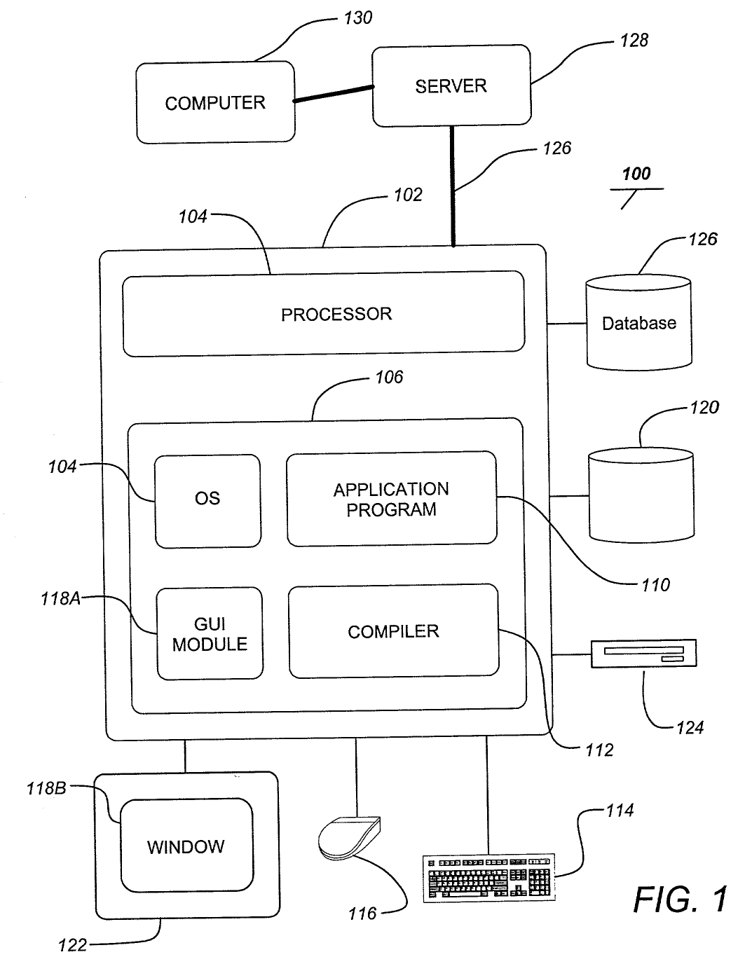

FIG. 1 illustrates an exemplary computer system 100 used to implement a multiple browser and editor. The computer 102 comprises a processor 104 and a memory 106, such as random access memory (RAM). The computer 102 is operatively coupled to a display 122, which presents images to the user. The computer 102 may be coupled to other devices, such as a keyboard 114, a mouse device 116, a printer, or similar I/O device. Any combination of the above components, or any number of different components, peripherals, and other devices, may be used with the computer 102.

Generally, the user interfaces with the computer which accepts inputs and commands and presents results through a graphical user interface (GUI) module 118A and window 118B. Although the GUI module 118A is depicted as a separate module, the instructions performing the GUI functions can be resident or distributed in the operating system 108, the application program 110, or implemented with special purpose memory and/or processors.

The operating system 108 and computer application program 110 are comprised of instructions which, when read and executed by the computer 102, causes the computer 102 to perform the steps necessary to implement and/or use the present invention. Computer program 110 and/or operating instructions may also be tangibly embodied in memory 106 and/or provided via data communications devices, thereby making a computer program product or article of manufacture according to the invention. As such, the terms “article of manufacture” and “computer program product” as used herein are intended to encompass a computer program accessible from any computer readable device or media. In one embodiment, instructions implementing the operating system 108, the computer program 110, and the compiler 112 are tangibly embodied in a computer-readable medium, e.g., data storage device 120, such as one or more fixed or removable data storage devices, a zip drive, floppy disc drive 124, hard drive, CD-ROM drive, tape drive, or other medium.

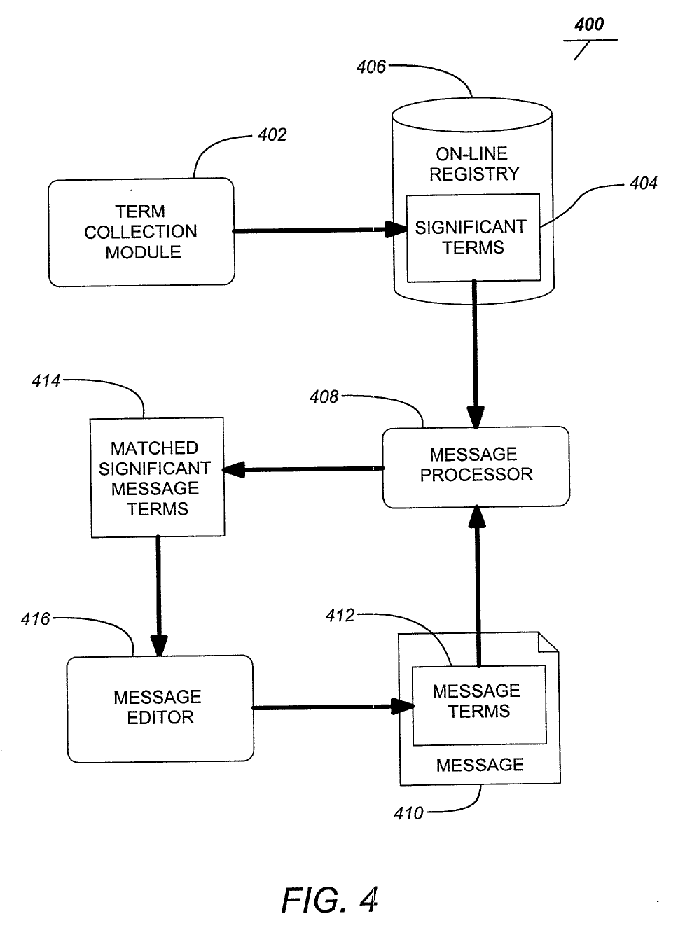

The computer system 100 also uses a network connection 126 (such as the Internet or a local area network) to facilitate connection to a server 128 and/or other computer systems 130. As will be apparent to those skilled in the art, the components of the invention (as will be detailed hereafter in reference to FIG. 4) may be implemented on an individual computer system 100 or across a network of servers 128 and computer systems 130.

Although other implementations are easily obtained, in a typical embodiment the present invention is a component of the computer application program 110, and particularly an application program 110 directed toward word processing and/or electronic message.

The computer 102 may also implement a compiler 112 which allows an application program 110 written in a programming language such as COBOL, C++, FORTRAN, or other language to be translated into processor 104 readable code. After completion, the application program 110 accesses and manipulates data stored in the memory 106 of the computer 102 using the relationships and logic that was generated using the compiler 112.

Of course, those skilled in the art will recognize many modifications may be made to this configuration without departing from the scope of the present invention. In addition, those skilled in the art will recognize that any combination of the above components, or any number of different components, including different computers, computer programs, peripherals, and other devices, may be used to implement the present invention, so long as similar functions are performed thereby.

### Logic of the Invention

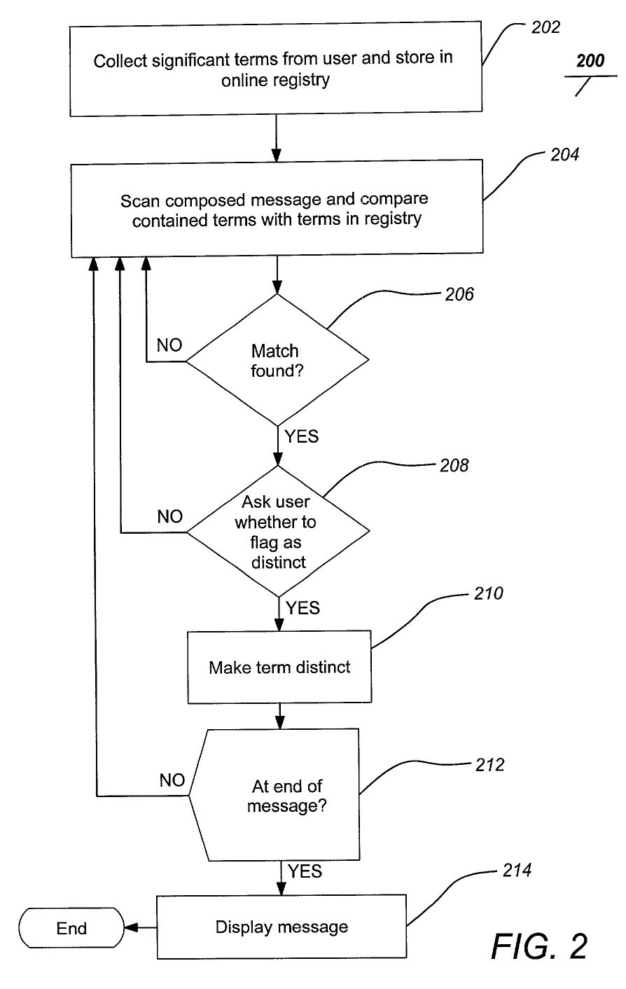

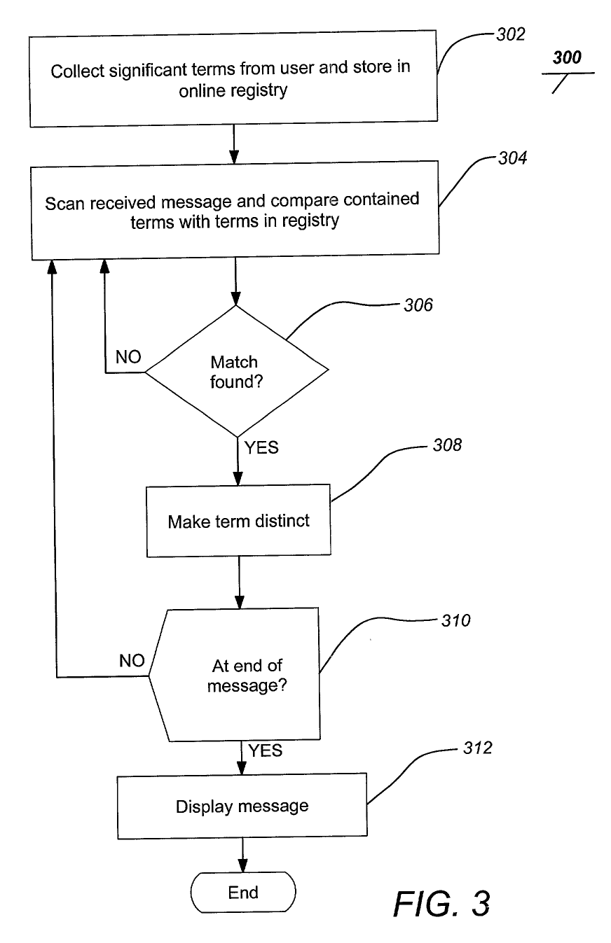

FIGS. 2 and 3 are flow charts illustrating preferred embodiments of the invention described above, one for use by an electronic message author and the other for use by an electronic message recipient.

FIG. 2 is a flowchart 200 that illustrates the logic performed by the invention for an electronic message author. First, significant terms are collected from a user and stored in an online registry at block 202. A composed message is scanned and the terms contained are compared with the terms in the registry at block 204. At block 206, if no match is found, the process continues scanning at block 204, but if a match is found, the process continues to block 208. At block 208, the process asks the user whether to flag or make distinct the matched term. If the response is no, the process returns to block 204 and then continues scanning. However, if the response is yes, the term is made distinct at block 210. Next, the process checks whether the end of the message has been reached at block 212 and if not, continues scanning to a next match at block 204. If the end of the message has been reached, message is displayed at block 214 and the process ends.

FIG. 3 is a flowchart 300 that illustrates the logic performed by the invention for an electronic message recipient. Here also, the process begins with significant terms collected from a user and stored in an online registry at block 302. A received message is scanned and the terms contained are compared with the terms in the registry at block 304. At block 306, if no match is found, the process continues scanning at block 304. If a match is found, the process continues to block 308, where the term is made distinct. Next, the process checks whether the end of the message has been reached at block 310 and if not, continues scanning to a next match at block 304. If the end of the message has been reached, the message is displayed at block 312 and the process ends.

The significant terms may be selected and made distinct in any manner, however, they are typically selected based upon profiles of an intended reader and/or the author. An example of a profile of the intended reader may be defined as “project team”. In this case, significant terms and settings will be selected and applied to a message based upon knowledge of the group—terms important to them, as well as specific ways of showing distinct terms. An author profile may include significant terms and settings that are applied when it is known who the author of the message is. In the foregoing example, a message from a member of “project team” may be processed using particular significant terms and settings. These significant terms and settings may be the same as for the reader profile. Reader profiles are applied when the message is processed by an author and author profiles are applied when the message is processed by a message recipient.

### Typical Embodiments

FIG. 4 illustrates a typical apparatus 400 of the invention which may be embodied in a single electronic message application or across different component hardware and software as previously described. The apparatus comprises a term collection module 402 which collects and stores the significant terms 404 in an online registry 406. The message processor 408 scans a message 410 (either received or authored by the user) and compares the message terms 412 to the significant terms 404 to identify any matched significant message terms 414 which are in both the message 410 and the registry 406. A message editor 416 then makes the matched significant message term 414 in the message distinct in some manner. If the user authored the message, they may be queried whether to proceed with making the matched terms distinct at each identified instance.

The manner in which matched significant message term 414 may be made distinct is not limited. Any alteration which allows a reader to readily identify the special significance of the term is sufficient. Some examples include alterations in the text font, color or effects (such as making text bold or underlined). Alternately, objects may be inserted in the message to make a term distinct, such as images, icons, videos, sounds or links. Of course, combinations of these techniques may also be employed.

The processing and editing of the message may be controlled through various user settings. One technique would be to categorize the significant terms and have the manner in which the matched terms are made distinct depend upon the category. For example, names of people from one particular organization (under a particular profile, for example) may be made bold and blue, while those from another organization (under the same or another profile) may be made bold and red. Of course, the “categories” can be as small as only a single word. Multiple categories of terms and user settings may be used in forming a particular reader or author profile.

The user settings may also control the processing of the message in determining which terms are significant and how they are to be altered. For example, the processor may first determine whom the message is being sent to and use those names as a temporary “category”, made significant in a particular manner. In this way, the user is able to completely customize and automate the operation of the invention.

The term collection module 402 may also include features beyond simply allowing a user to manually enter terms. A user may simply select a term in any message being read and send it to the registry. Terms may also be imported from address books and other databases. In addition, incoming messages may be analyzed for terms, such as sender names and proposed as a new entry to the user (or automatically captured). The term collection module may also facilitate the categorizing of terms and the formation of profiles as discussed above.

The online registry 406 of terms may be stored at the users local system 100 or on a network so that they are available to the user whenever and wherever a user receives or composes messages.

Numerous applications using the present invention will be apparent to those skilled in the art. The following examples describe a few typical uses of the present invention in various applications.

### EXAMPLE 1

### For Authors of Electronic Messages

In an electronic message application (e.g. Lotus Notes), an option is provided on a menu (e.g. the Edit menu) named “Collect key names/terms” or similar. Selecting this option opens a dialog where the user can select, type in, or otherwise specify terms of importance/significance. Some examples of useful categories of terms are names of co-workers (which could be imported from the user's personal address book), key product terms and names (e.g. “XYZ product”, “Install Team”, “Human Resources”, etc.) and key words used in user's particular field (e.g. “XML”, “HTML”, etc. for an internet programmer). When the user is done in this dialog, a registry of these terms is built and kept and stored for the user, on the user's machine or a server, for example.

The program may also provide an option on an edit menu named “Flag key names/terms”. This option would be available when the user is composing a new electronic message. This option opens a dialog similar to a “spell-check” window where the user can indicate that the program should scan through the electronic message and make distinct any term that matches any of the key names/terms that are in the registry collected earlier, or flag any names of people in the “To:” list that also appear in the body of the message. When a key term is flagged, the user has the option in the dialog of specifying how to indicate that the term is significant. For example, the program may make the term a different font, make the term a different color, add an image next to the term, or attach a sound file on the term. Of course, the manner of making a term distinct may also be automated as previously described.

At the end of the process, the result is an electronic message that has terms that are in different fonts, colors, etc. to signify to the recipients those places that they should pay attention. For example, key names from the “To:” list are flagged in bright bold red at places where they have actions to do; different colors are used for some people and bold font is used for status, install and build. In the following example, the author chooses not to make bold every occurrence of “install” and “build”; just the ones where he thought it would make a difference:

To: Eva Jones, Alan Harmon, Elizabeth Grayson, John Hayes

From: Clark Kent

Subject: To-Dos and brainstorming

Please send me status on the items below by 11:00, 2:00, 4:00, and 6:00 tomorrow by electronic message Please include defect number and what happened with it. I'm leaving at 10:30, after 2 meetings and won't have time to stop by and get status. Call me for emergencies.

We need to have people on call this weekend; please work something out between you; someone will need to check throughout the weekend to make sure further defects are covered and closed.

Elizabeth and Eva: using the Thursday night build, can you test the following defects: 34509, 116916, 116510

Eva: Verify old defects, close. Check with John Hayes which ones were already verified (116916, 116927 were new ones yesterday). Also test fix for 115236 (will need to be in weekend build).

John: Check for new defects, verify, and necessary changes to Eva for fixes. Finish defect 116508.

Alan: Finish defects with Solaris

Later, I think we should discuss this process, in light of the new function updating and roles involved. Perhaps we should really have an install rep as well as a build rep, since we do have a somewhat different perspective on many issues. The install team usually gets hooked in at the end of the cycle, while the build team is there from the start. A lot of these problems seem to be related to install.

There may even be other strategically positioned experts who could also help.

Thanks!

Clark

### EXAMPLE 2

### For Recipients of Electronic Messages

Identical to the foregoing, except that in this case the author doesn't process the message before sending. This may occur if the author has neglected to or does not have access to software implementing the invention when drafting or sending the message. It should also be noted that even if the author has processed the message, the recipient may independently collect terms that the user deems important and process the message supplementally. Using the above example and assuming the electronic message author neglected or is unable to process the message, if the recipient is Elizabeth, she might just want to see if her name is in the message. She would see the above incoming message flagged as follows.

To: Eva Jones, Alan Harmon, Elizabeth Grayson, John Hayes

From: Clark Kent

Subject: To-Dos and brainstorming

Please send me status on the items below by 11:00, 2:00, 4:00, and 6:00 tomorrow by electronic message. Please include defect number and what happened with it. I'm leaving at 10:30, after 2 meetings and won't have time to stop by and get status. Call me for emergencies.

We need to have people on call this weekend; please work something out between you; someone will need to check throughout the weekend to make sure further defects are covered and closed.

Elizabeth and Eva: using the Thursday night build, can you test the following defects: 34509, 116916, 116510.

Eva: Verify old defects, close. Check with John Hayes which ones were already verified (116916, 116927 were new ones yesterday). Also, test fix for 115236 (will need to be in weekend build).

John: Check for new defects, verify, and necessary changes to Eva for fixes. Finish defect 116508.

Alan: Finish defects with Solaris

Later, I think we should discuss this process, in light of the new function updating and roles involved. Perhaps we should really have an install rep as well as a build rep, since we do have a somewhat different perspective on many issues. The install team usually gets hooked in at the end of the cycle, while the build team is there from the start. A lot of these problems seem to be related to install.

There may even be other strategically positioned experts who could also help.

Thanks!

Clark

So, when Elizabeth opens the electronic message, her eye would be drawn to the line that begins with her name immediately, and she can read that part first. This ensures that it gets her attention.

Without the present invention, an author may manually type the names of people next to the sections or questions in the electronic message that the author wants to receive special attention, and then highlight the names (using different fonts or colors) to call attention to those sections. The disadvantage to this method is that it requires significant time to go to each occurrence within the message, selecting the name or words at each occurrence, and then changing the font or color to make it stand out. Furthermore, there is a risk of overlooking an occurrence that should be highlighted, especially in a long electronic message. See the following example.

To: Ellen, Eric, Brian, David

From: Elizabeth

Subject: Question about translation practices

Hi team,

I have a question for you that came from another team. The question is if we use a tool that doesn't generate table of contents automatically, how do the translators “sync up” the translation of the headings? Is there a step in the process where they compare to make sure they've translated the same English heading text into the same language text? Ellen or Eric, do you know how they handle this scenario?

David, from an accuracy/clarity/retrievability standpoint, I always assume that it's in the best interest of the users that the text matches, so that they are ensured that they have jumped to the correct corresponding panel. The example quoted was “Choosing a controller” instead of “Selecting a controller” in the heading of the panel it links to. What are your thoughts on this issue? If you think it's something that could cause a lot of customer problems, then we might need to put a process in place to ensure that they always match exactly. Do you know which team could handle this, Standards or Procedures? Could you call a meeting with the appropriate team to discuss it?

Thanks!

Elizabeth

In the above example, the author must type the entire message, then go back and choose various fonts and colors and select the text to highlight. The advantages of the invention over this manual alternative are that the process is made faster, easier and certain. In one embodiment of the invention, the author would only have to type the original message, hit a button, and the tool would pick out the names and, depending on the particular format selection, make all the names in bold font.

As previously mentioned, in another embodiment of the invention, electronic message recipients may specify key words that they want to have identified in the electronic messages that they receive when they open the messages to read them, instead of relying on the author having specified them when the author sent the message. So that, if the author forgets to highlight the name of a recipient in the body of the electronic message (or doesn't have the tool available), the recipient could turn on the invention to look for and highlight her own name or certain other names or words that she's specified in a personal “dictionary” and automatically see those words easily.

For example, suppose the above message is sent to Eric, Ellen, Brian, and David and the author either forgot to run the tool to flag their names or does not have the tool.

David is the head of the Standards team. With an embodiment of this invention in his electronic message program, he could have registered a set of key words that includes his name (“David”), and the terms “meeting” and “Standards”, so that he can easily see his name in any messages that come in and whether there might be an issue for him or his team and for meetings. So, when the message arrives and he opens it, the words “meeting”, “Standards” and “David” will be highlighted and he can see them easily with the items that are important for him and his team:

To: Ellen, Eric, Brian, David

From: Elizabeth

Subject: Question about translation practices

Hi team,

I have a question for you that came from another team. The question is if we use a tool that doesn't generate table of contents automatically, how do the translators “sync up” the translation of the headings? Is there a step in the process where they compare to make sure they've translated the same English heading text into the same language text? Ellen or Eric, do you know how they handle this scenario?

David, from an accuracy/clarity/retrievability standpoint, I always assume that it's in the best interest of the users that the text matches, so that they are ensured that they have jumped to the correct corresponding panel. The example quoted was “Choosing a controller” instead of “Selecting a controller” in the heading of the panel it links to. What are your thoughts on this issue? If you think it's something that could cause a lot of customer problems, then we might need to put a process in place to ensure that they always match exactly. Do you know which team could handle this, Standards or Procedures? Could you call a meeting with the appropriate team to discuss it?

Thanks!

Elizabeth

The present invention may expand upon the functionality of a “spell checker”, known and used in many word processing applications. An example spell checker may function as follows.

1. The author composes the message.

2. The author runs spell-check tool.

3. The spell-check tool compares terms in the message against an online registry of terms (the dictionary).

4. One at a time, the spell-check tool flags those terms that the spell-check tool deems possibly misspelled terms important to the author.

5. When each occurrence is flagged, the author is given an opportunity to ignore or change the flagged terms.

6. At finish, the author sends the message.

The present invention extends the concept of comparing terms contained in an authored message to a registry of terms, flagging those of “interest”, and giving the author an opportunity to change them or otherwise modify the message.

1. The author composes the message.

2. The author runs a tool that is an embodiment of the present invention.

3. The tool compares terms in the message against an online registry of terms that the author has created. For example, the registry may contain names of people that the author has registered, names of people in the “To:” list of the current message, proper names of things in the author's workplace, etc.

4. One at a time, the tool may flag those terms that match ones in the registry that the author has created, indicating that the author deems them significant terms.

5. At each identified match, the tool gives the author an opportunity to specify that the term be given a distinct quality (for example, a different font, or a color, or a sound attached, or an image attached) to indicate its importance when the message is opened by the recipient. Alternately, the author may preset the processing to occur automatically, without prompting at each identified match.

6. At finish, the author sends message.

The present invention differs from a simple spell-checker in many ways. The present invention employs a registry that the users define themselves with words that are of personal importance. A spell-checker is based on the paradigm of flagging those terms that do not match its registry and providing an option to replace terms. The present invention flags those terms that do match and allows the user to attach significance to those terms through reformatting the terms or by appending other markers (such as sounds or images).

Another related concept is the search feature in electronic message applications. The search concept for the recipient of the electronic message is:

1. The recipient receives electronic message.

2. The recipient opens the search tool.

3. The recipient specifies significant words that the recipient wants to find within the message.

4. At each found occurrence, the recipient reads that section.

The present invention extends this concept in a novel way by searching through an electronic message for any term that the user (author or recipient) has specified ahead of time (i.e. preset) as having significance or importance for them, not just searching for a single term that the user enters in the search tool, and by allowing the occurrences of terms to be flagged in some way within the electronic message itself If the author processes the message with an embodiment of the invention, the recipient does not have to search through the message at all; all of the important terms will be flagged with some significance (font, color, image, sound, etc.) that is readily visible to the recipient. In addition, the invention is not as tedious for the recipient as using a search tool. Instead of having to run the search for every term that has significance for the recipient and that they think might be in the electronic message (for example, searching for the user's name, then searching for a product name, etc.), the recipient sets up a registry of terms at one point in time and then only runs the invention against each electronic message. Each occurrence is flagged (by font, color, image, sound, etc.) and the recipient can see them stand out within the electronic message.

### Conclusion

This concludes the description of the preferred embodiment of the invention. In summary, the present invention comprises a method, apparatus and article of manufacture for use in an electronic messaging system.

The following describes some alternative ways of accomplishing the present invention. Those skilled in the art will recognize that different operating environments, electronic message and internet systems, applications, editors etc., could be substituted for those described herein. Those skilled in the art will also recognize that the present invention could be used in any type of computer system. In addition, those skilled in the art will recognize that the present invention can be used with many types of other applications, and need not be limited to the example applications and systems described herein.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for identifying and distinguishing words contained within an electronic message, comprising the steps of:
scanning and comparing message terms in an electronic message to significant terms from an online registry to identify any matched significant message terms; and
making distinct the matched significant message term to indicate significance to a reader.

2. The method of claim 1, wherein the electronic message is an authored electronic message.

3. The method of claim 1, wherein the electronic message is a received electronic message.

4. The method of claim 1, wherein the significant terms are determined based upon a reader profile.

5. The method of claim 1, wherein the significant terms are determined based upon an author profile.

6. The method of claim 1, wherein the matched significant message terms are made distinct based upon a reader profile.

7. The method of claim 1, wherein the matched significant message terms are made distinct based upon an author profile.

8. The method of claim 1, further comprising the step of collecting and storing significant terms in the online registry.

9. The method of claim 8, wherein the step of collecting and storing comprises a user selecting significant terms.

10. The method of claim 8, wherein the step of collecting and storing comprises importing significant terms.

11. The method of claim 10, wherein significant terms are imported from an address book.

12. The method of claim 10, wherein significant terms are imported from a database.

13. The method of claim 1, wherein the significant terms are selected from the group comprising names of people, product terms and key words in a user's field.

14. The method of claim 1, wherein making the matched significant message term distinct comprises making the matched significant message term a different color.

15. The method of claim 1, wherein making the matched significant message term distinct comprises making the matched significant message term a different font effect.

16. The method of claim 1, wherein making the matched significant message term distinct comprises making the matched significant message term a different font type.

17. The method of claim 1, wherein making the matched significant message term distinct comprises inserting an object near the matched significant message term.

18. The method of claim 17, wherein the object is selected from the group comprising an image, a sound file, an icon, a link and a video.

19. The method of claim 1, wherein making the matched significant message term distinct is performed according to a user setting.

20. The method of claim 19, wherein the significant terms are categorized and the user setting is based upon a category of the significant term.

21. The method of claim 1, further comprising the step of displaying the electronic message if the end of the electronic message has been reached.

22. The method of claim 1, further comprising the step of querying a user whether to make the matched term distinct.

23. An apparatus for identifying and distinguishing words contained within an electronic message, comprising:
an electronic message processor for scanning and comparing message terms in an electronic message to significant terms in an online registry to identify any matched significant message terms; and
an electronic message editor for making distinct the matched significant message term to indicate significance to a reader.

24. The apparatus of claim 23, wherein the electronic message is an authored electronic message.

25. The apparatus of claim 23, wherein the electronic message is a received electronic message.

26. The apparatus of claim 23, wherein the significant terms are determined based upon a reader profile.

27. The apparatus of claim 23, wherein the significant terms are determined based upon author profile.

28. The apparatus of claim 23, wherein the matched significant message terms are made distinct based upon a reader profile.

29. The apparatus of claim 23, wherein the matched significant message terms are made distinct based upon an author profile.

30. The apparatus of claim 23, further comprising a term collection module for collecting and storing the significant terms in the online registry.

31. The apparatus of claim 30, wherein collecting and storing comprises a user selecting significant terms.

32. The apparatus of claim 30, wherein collecting and storing comprises importing significant terms.

33. The apparatus of claim 32, wherein significant terms are imported from an address book.

34. The apparatus of claim 32, wherein significant terms are imported from a database.

35. The apparatus of claim 23, wherein the significant terms are selected from the group comprising names of people, product terms and key words in a user's field.

36. The apparatus of claim 23, wherein making the matched significant message term distinct comprises making the matched significant message term a different color.

37. The apparatus of claim 23, wherein making the matched significant message term distinct comprises making the matched significant message term a different font effect.

38. The apparatus of claim 23, wherein making the matched significant message term distinct comprises making the matched significant message term a different font type.

39. The apparatus of claim 23, wherein making the matched significant message term distinct comprises inserting an object near the matched significant message term.

40. The apparatus of claim 39, wherein the object is selected from the group comprising an image, a sound file, an icon, a link and a video.

41. The apparatus of claim 23, wherein making the matched significant message term distinct is performed according to a user setting.

42. The apparatus of claim 41, wherein the significant terms are categorized and the user setting is based upon a category of the significant term.

43. The apparatus of claim 23, further comprising the step of displaying the electronic message if the end of the electronic message has been reached.

44. The apparatus of claim 23, further comprising the step of querying a user whether to make the matched term distinct.

45. An article of manufacture embodying logic for identifying and distinguishing words contained within an electronic message, comprising the steps of:
scanning and comparing message terms in an electronic message to significant terms from an online registry to identify any matched significant message terms; and
making distinct the matched significant message term to indicate significance to a reader.

46. The article of claim 45, wherein the electronic message is an authored electronic message.

47. The article of claim 45, wherein the electronic message is a received electronic message.

48. The article of claim 45, wherein the significant terms are determined based upon a reader profile.

49. The article of claim 45, wherein the significant terms are determined based upon an author profile.

50. The article of claim 45, wherein the matched significant message terms are made distinct based upon a reader profile.

51. The article of claim 45, wherein the matched significant message terms are made distinct based upon an author profile.

52. The article of claim 45, further comprising the step of collecting and storing significant terms in the online registry.

53. The article of claim 52, wherein the step of collecting and storing comprises a user selecting significant terms.

54. The article of claim 52, wherein the step of collecting and storing comprises importing significant terms.

55. The article of claim 54, wherein significant terms are imported from an address book.

56. The article of claim 54, wherein significant terms are imported from a database.

57. The article of claim 45, wherein the significant terms are selected from the group comprising names of people, product terms and key words in a user's field.

58. The article of claim 45, wherein making the matched significant message term distinct comprises making the matched significant message term a different color.

59. The article of claim 45, wherein making the matched significant message term distinct comprises making the matched significant message term a different font effect.

60. The article of claim 45, wherein making the matched significant message term distinct comprises making the matched significant message term a different font type.

61. The article of claim 45, wherein making the matched significant message term distinct comprises inserting an object near the matched significant message term.

62. The article of claim 61, wherein the object is selected from the group comprising an image, a sound file, an icon, a link and a video.

63. The article of claim 45, wherein making the matched significant message term distinct is performed according to a user setting.

64. The article of claim 63, wherein the significant terms are categorized and the user setting is based upon a category of the significant term.

65. The article of claim 45, further comprising the step of displaying the electronic message if the end of the electronic message has been reached.

66. The article of claim 45, further comprising the step of querying a user whether to make the matched term distinct.
